(19) United States
(12) Patent Application Publication
(10) Pub. No.: US 2015/0026021 A1
(43) Pub. Date: Jan. 22, 2015

(54) Computer Implemented Reporting System and Method

(71) Applicant: Anjum KHAN, (US)

(72) Inventor: Anjum Khan, Cardiff (GB)

(21) Appl. No.: 14/385,132

(22) PCT Filed: Mar. 8, 2013
(86) PCT No.: PCT/GB2013/050574

§ 371 Date: Sep. 12, 2014

(30) Foreign Application Priority Data
Mar. 15, 2012 (IN) 946/CHE/2012

(51) Int. Cl. G06Q 40/00; G06Q 10/10

(52) U.S. Cl. CPC G06Q 40/12; G06Q 40/125; G06Q 10/1091
USPC 705/30

(57) ABSTRACT

A computer-implemented system is provided for managing a commercial entity and providing reports. The system comprises a cloud-based reporting component configured to receive transaction-related data from at least one electronic device located at the entity; process the transaction-related data to generate a cash-sheet reconciliation report; communicate at least a portion of the pre-processed or processed data to an accounting component; and provide the cash sheet reconciliation report to a user associated with the entity. The electronic device could be a Point-of-Sale device, cash register, refrigeration apparatus, identity-verification apparatus, or security-related device. The system can be further configured to receive non transaction-related data relating to the entity, in respect of an environmental factor, the status of a device, an employee or other person, or a customer. The system provides an intermediary component which replaces the role of a book keeper by integrating the data from the devices with an accountancy software component.

The present invention relates generally to a system and method for generating reports relating to the operations of a commercial enterprise to facilitate the management of said enterprise. More particularly, it relates to the collection and processing of transactional (financial) data and non transactional data to provide an effective tool for overseeing the on-going operations of the enterprise; and to a system and method for integrating cash sheet management with an accounting and payroll system in a cloud-based computing network.

Commercial enterprises often function in today's world as global value networks rather than colossal entities. This makes it imperative to stay connected with a comprehensive enterprise environment. Advances and innovations in computing related technology has facilitated this communication and connectivity, and has altered the way in which managers of commercial organizations use, view and share their data.

Commercial entities generate, process and provide a great deal of data, of varying types and from a variety of sources, on an ongoing basis during their daily operations. For example, transactional data is generated each time a financial operation takes place, such as the sale or purchase of goods. Other types of data are also recorded and used by the managers of such entities (e.g. shops). For example, data relating to the number of hours an employee has worked is required not only for payroll purposes so as to calculate wages but perhaps for other purposes, such as compliance with employment legislation. Other types of data might be required for yet other purposes, such as complying with health and/or safety requirements or legislation. For example, the temperature of a refrigeration unit might need to be checked and monitored by law.

Thus, in order to run his business effectively and efficiently, today's manager must have ready access to all sorts of financial and non-financial data. if the data is difficult to access, difficult to understand, and/or delayed in its availability, its value may be eroded or even possibly destroyed.

Computing-related technology (both hardware and software) assists greatly in the management, collection and processing of such data in commercial environments.

Some of the computing technology employed for these purposes is cloud-based technology. The term ‘cloud computing’ refers to the provision of processing and/or storage resources as a service to a heterogeneous community of end users. Services are entrusted with a user's data, software and computation over a network, which is usually the internet. End users access cloud-based applications through a web browser, virtual machine or mobile application (app) while the business software and data are stored on servers provided at a remote location.

Cloud-based systems capitalise upon the sharing of physical and programming resources. Application programming interfaces (APIs) enable computers and other systems to ‘plug into’ and interact with software residing in the cloud. This connectivity has provided great rewards for many end users, who are freed of the burden of maintaining, housing and managing their own in-house computing resources.

The device and location independence provided by cloud-based architectures enables users to access systems using a web browser regardless of their location or the type of device they are using (e.g., PC, mobile phone). As the cloud-based infrastructure is off-site (typically provided by a third-party) and accessed via the Internet, users can connect from anywhere to access the information they require.

These advantages offered by the cloud-based computing environment have been recognized within the managerial/commerce community, and some managerial computing systems are provided as (at least partially) cloud-based solutions. Such systems include POS systems, accounting software and ERP systems.

### Point of Sale (POS) System

The high volume and frequency of daily cash flow associated with many businesses makes a Point of Sales (POS) system essential. The retailing industry is one of the predominant users of POS terminals. Currently, most retailers use either a standalone POS system or the POS system provided by their group/franchisor/manufacturer for the operations in their retail outlets.

A retail point of sales system typically includes a computer, monitor, cash drawer, receipt printer, customer display and a barcode scanner. The majority of retail POS systems also include a debit/credit card reader. They can also include weighing scales, integrated credit card processing system and a signature capture device. More and more POS monitors use touch-screen technology for ease of use and a computer is built into the monitor chassis for what is referred to as an all-in-one unit.

While the POS unit (station) handles the sales to the consumer, this is only one aspect of the entire POS system as typically used in today's retail organisations. Back-office computers typically handle other functions of the POS system such as inventory control, purchasing, receiving and transferring of products to and from other locations. Other typical functions of a POS system are to record employee attendance, store sales information for reporting purposes, sales trends and cost/price/profit analysis. The customer information may be stored for receivables management, marketing purposes and specific buying analysis.

Conventional attendance capture systems may include a plurality of tracking systems to monitor the employees working within an organisation. Some of the well known capture systems are punch-in devices, biometric readers, swipe cards with magnetic stripes, proximity sensors, RFID-based attendance tracking systems, 3D face recognition systems, surveillance cameras and so on.

Attendance monitoring systems enable the employer to pay the employees in a timely and accurate manner. Payroll processing is a major expense for most companies—employee wages/salaries typically comprise a large percentage (if not the largest percentage) of an organisation's budget. A timesheet is often used to record the amount of time a member of staff has spent on a particular job or during a given shift, and may include start and end time of tasks. Timesheets may be used for payroll, client billing and increasingly for project costing, estimation, tracking and management. POS systems can be used to record attendance data—for example, when the employee ‘logs in’ to a device such as an electronic cash register using a bar code or by entering an employee code.

Therefore, POS systems can provide the user (business manager) with a useful tool for collecting, processing and reporting data relating to the on-going (e.g. day to day) operations of the business.—for example, by capturing financial and attendance data each day, and then using this to generate end-of-day reports for cash tills and employee attendance reports. However, such data is also needed for ‘longer term’ purposes such as trend monitoring and accountancy requirements, and so it needs to be fed into some other faun of software for those purposes.

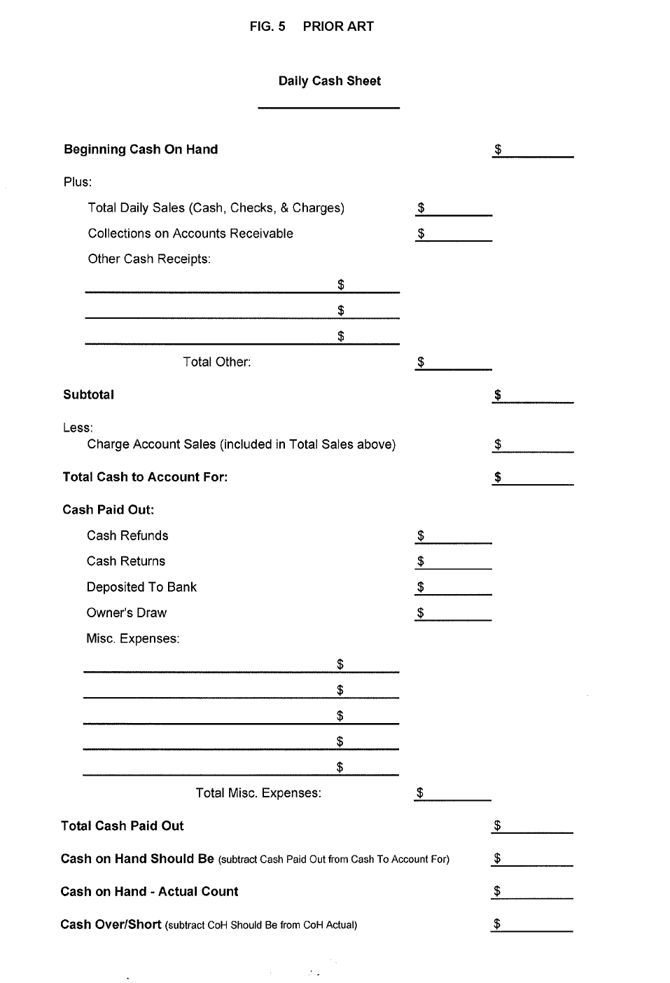

One important and very common form of on-going operational data is compiled in a form known as a ‘cash sheet’. A cash sheet is a daily reconciliation of cash received and cash paid out from the POS. An example of a simple cash sheet is shown in FIG. 5. It can also include the login in/log out (time) details for employee attendance which will be used to calculate their wages. In the retail store, the cash sheet is generally prepared at the end of each day. The cash sheet information is collected from each of the cash registers (‘tills’) of the various POS within the business and the attendance capture systems. The cash sheet information is managed by the store administration staff. Further, the store manager/administrative staff usually deposits all cash receipts into the relevant bank account or handle their collection by a designated individual or a cash collection agency on a regular basis, based upon the particular business needs.

Within a hierarchical organization, operational data generated daily at the individual business locations (e.g. at each retail outlet, shop, restaurant etc.) will need to be communicated to the higher level management (e.g. at head office) for their reporting, accounting, forecasting purposes. At present, the daily trading/management information (including attendance data) generated at the individual business location is conveyed to the account/management office through manual paperwork, or through a plurality of communication mediums such as email, SMS messages, telephone calls, online spreadsheets and so on. Thus, the daily operational information produced by the POS system is manually fed into other software systems (e.g. accounting software) for further processing and/or distribution, to at the very last requires some degree of human intervention. It is not a fully automated process.

For accounting and payroll functions, additional software applications must be provided in addition to the POS software because POS software does not provide the complex functionality required by organizations for higher level managerial purposes. Cash sheet information obtained from the POS and the attendance system has to be entered manually into the accounting and payroll system respectively.

### Accounting Software

Accounting is concerned with the communication of an organisation's financial information to interested parties such as managers, shareholders and regulatory/governmental bodies. The communication generally takes the form of financial statements. In particular, ‘management accounting’ (also known as ‘managerial accounting’) is concerned with providing accounting information to managers within organizations so as to provide them with the basis for making informed business decisions. By providing managers with appropriate financial information relating to their organization, those managers are able to understand and control their organizations more effectively.

Typical modules included in accounting software solutions include:
Accounts receivable—where the company enters money received
Accounts payable—where the company enters its bills and pays money it owes
General ledger—the company's “books”
Billing—where the company produces invoices to clients/customers
Stock/Inventory—where the company keeps control of its inventory
Purchase Order—where the company orders inventory
Sales Order—where the company records customer orders for the supply of inventory
Cash Book—where the company records collection and payment

However, there is no cash sheet reconciliation functionality provided.

The most sophisticated form of business accounting software is typically provided as a component within a complex group of related and integrated software applications, known collectively as ‘Enterprise resource planning’ or ERP software.

### Enterprise Resource Planning (ERP) Systems

These software applications integrate various functional software components designed for distributed enterprises and their supply chains. ERP systems have delivered proven value in reforming enterprise processes. ERP systems integrate information from a variety of internal and external sources for a variety of purposes, including finance/accounting, manufacturing, sales and service, customer relationship management. Such ERP systems use a suite of integrated software components to automate such commercial activities, and to facilitate the flow of information both within the business and to/from the external entities.

In some organizations, more than one software application may exist to support a particular aspect of the operational requirements. This often results in a diverse set of software applications, each performing its own role and function, but requiring data sharing and integration. An ERP system tries to solve this problem by offering one solution for every operational requirement. An ERP system usually maintains one shared database for all data, integrated processes among the different departments, a consistent interface for every user and homogeneous reports/score cards that display operational data of the whole organization.

While ERP systems can effectively support specific business processes, they are typically custom-built for an individual organisation and its functional requirements. This means that such systems take a long time to implement and are extremely expensive, taking them out of the financial reach of small to medium sized organisations.

Therefore, there is a need in the art to develop an integrated system for businesses having their network-outlets located in diverse geographical locations, effectively providing functionalities required for managing day to day operations related to cash transactions, cash balances, funds transfer, bank account reconciliations, employee attendance etc. in a real-time environment and integrate with the accounting & payroll system that can be made accessible from anywhere to the authorized persons to take effective management decisions.

There is a need to integrate the POS system with the accounting software, such that data generated in the former can be used for managerial reporting purposes and provided to the latter without the need for the time consuming, costly and error-prone manual input. While existing POS systems provide part of the solution, and existing accounting software also provides part of the solution, no known solution incorporates all of the functionality required on a daily, regular basis by managers.

Drawbacks associated with the current arrangements include:
While current POS systems can provide effective tools for collecting daily operational data, they do not provide a means for generating (more sophisticated) managerial reports which include all of the data often required by a user (manager);
data obtained from POS systems has to be manually fed into (input) into more sophisticated reporting software such as accounting software;
while accounting software can provide an effective tool for generating financial statements and accounting reports, it does not provide operational information (such as cash sheet reconciliations) which are required by managers on an ongoing, usually daily basis;
monitoring or further processing of the consolidated daily trading information (e.g. cash sheets) related to sales, receipts, and expenses of interconnected retail outlets currently takes a significant time to reach the account/management office;
the manual data entry is prone to errors, and a significant amount of personnel effort is required;
the lengthy implementation time and significant development cost of customized, proprietary reporting software renders this option unfeasible for any parties other than very large organizations.

Therefore, a solution is required which bridges the gap between the functionality of existing POS systems and existing accounting software, and provides a flexible reporting tool to facilitate management of a commercial enterprise.

Such an improved solution has now been devised.

Thus, in accordance with the present invention, there is provided a computer-implemented system for managing a commercial entity and comprising a cloud-based reporting component configured to:
receive transaction-related data from at least one electronic device located at the entity;
process the transaction-related data to generate a cash-sheet reconciliation report;
communicate at least a portion of the pre-processed or processed data to an accounting component;
provide the cash sheet reconciliation report to a user associated with the entity.

Preferably, the system is configured to receive the data, process the data, communicate the data and/or provide the report in real-time.

Preferably, the reporting component is a software component executing upon a processor.

Preferably, the accounting component is a software component executing upon a processor. The accounting component and the cloud-based component may be integrated. The accounting component may be cloud-based.

Preferably, the reporting component may be configured to format or process the data prior to communicating it to the accounting component. Therefore, the reporting component acts as an intermediary resource sitting between the electronic data sources and the accounting software. The reporting component gathers the incoming data from the business, processes it to produce the cash sheet reconciliation report required by the user for his on-going managerial tasks, and in turn provides the data to the accounting component. The accounting component can then use the data in accordance with known techniques e.g. to produce tax returns and for use in auditing processes. This provides the benefit that the user can have easy and instant access to the operational information required for day-to-day management of the business whilst knowing that the data is also being seamlessly fed into the accounting component at the back end of the system for higher level (i.e. longer-term) accounting purposes. Another advantage of this arrangement is that the cash sheet information does not need to be manually input into the accounts software after the cash sheet report has been produced, as is the case with prior art approaches. Not only does this save time (and therefore money) but it also reduces the risk of error which is commonplace when manual data entry is used.

It should be noted that the term ‘entity’ or phrase ‘commercial entity’ is used herein to refer to any type of commercially-oriented organization. For example, the entity might be a retail outlet, a shop (or ‘store’), a restaurant, a food outlet, a goods distribution business, a not-for-profit or charitable organisation or any other business entity whose activities involve financial transactions. The invention is not intended to be limited in regard to the nature of the business entity concerned.

The transaction-related data may relate to financial operations occurring at the entity. For example, the transaction-related data may relate to the sale of an item. It may, for example, include purchase data, expense data, and/or bank deposit data.

The transaction related data may be received from one electronic device or a plurality of electronic devices. For example, it may be received from a plurality of electronic tills and/or electronic point-of-sale systems, or a combination thereof. Other types of electronic device may also be used to collect the transaction related data for communication to the reporting component.

The at least one electronic device may be a Point-of-Sale device, or a cash register, or refrigeration apparatus, or identity-verification apparatus, a security-related device or other source of electronic data.

Beneficially, the reporting component is further configured to receive non transaction-related data. The non-transactional data may relate to at least one of:
an environmental factor present within the entity; (such as the ambient temperature)
the status of a device operating within the entity; (such as the temperature within a refrigeration unit; or the operational status of an alarm e.g. on or off)
an employee or other person operating within the entity; (such as the time the employee started work)
a customer making a transaction within the entity; (such as the identify and/or age of the customer).

Other types of non-transactional data may be received and processed by the system in addition to or instead of the above.

Beneficially, the system is configured to process the non-transaction related data to generate a management report relating to operations or activities occurring within the entity.

The management report may provide information for the user relating to regularly-occurring or daily activities which take place within the commercial entity. The management report may include, for example, employee attendance information and/or payroll information.

The non transaction-related may relate to (for example):

the temperature within the commercial entity or a refrigeration device at the entity; employee working hours;
licensing or other statutory/legislative requirements;
customer or personnel verification, such as biometric data for establishing the identity or age of a person. For example, certain substances such as alcohol may only be sold to persons of a certain age and so the customer's age may need to be verified.

Preferably, at least a portion of the transaction-related data is received from the at least one electronic device without manual input of the data and/or manual intervention. Therefore, at least some data is sent automatically to the system without human input. This saves time for the user/employee/personnel and also reduces the chance of mistakes occurring due to erroneous manual data entry. This in turn saves money and preserves the integrity of the data.

Preferably, an on-screen interface may be provided to enable the user to:
input (transaction related and/or non transaction related) data for sending to the reporting component;
access data previously received by the reporting component; and/or
access the report generated by the reporting component.

Thus, some of the data may be input into the system manually by the user or some operative working in association with the commercial entity. This provides the advantage that some types of data which are not readily available from electronic sources can be input into the system, and/or entities which are not fully automated in all operational respects are still able to enter some of their data manually. This provides a flexible data entry facility which can be tailored according to the entity's resources.

The commercial entity may comprise a plurality of sub-entities. For example, the entity may be made up of more than one retail outlet, or several restaurants, or a plurality of cafes.

The reporting component may receive the transaction-related data from one, some or all of the sub-entities. Thus, for example, each of the shops within the organization may provide their data to the reporting component for processing. Each sub-entity (e.g. individual shop) may have one or more electronic devices provided therein. Therefore, in certain embodiments the reporting component may receive and process data sent from a variety of sources within more than one shop.

The cash sheet reconciliation report may include information relating to at least one of the sub-entities. For example, a manager who is responsible for a chain of stores may be provided with a cash sheet and/or managerial report for each store under his supervision.

The reporting component may be configured such that the management report and/or the cash sheet reconciliation report can be customised to include or exclude information specified by the user. This provides the benefit that the user can tailor the report(s) to suit his individual needs. Only the required information which is relevant to his managerial requirements can be selected for inclusion in the report. This enables the user to monitor exactly what he needs, thus saving time and effort on his part.

The management report and/or the cash sheet reconciliation report may be generated on a pre-scheduled basis (e.g. at the end of each working day) or upon demand by the user. This provides a flexible solution which enables the user to access the information he needs whenever he needs it.

The management report and/or the cash sheet reconciliation report may be provided to the user via electronic means and/or in a digital format. Either or both of the reports may be provided to the user via an email message, or by an SMS message, or by display via a web browser, or by transfer via the internet. The user may receive one or both of the reports to from the system on any type of electronic device, including a computer (laptop or desktop), or a mobile phone. Other types of device and/or delivery format are not intended to be excluded from the scope of the invention. This provides the advantage that the user can access the information from any geographical location where a suitably configured electronic device is provided.

Preferably, an on-screen interface may be provided to facilitate manual input (entry) of the transaction and/or non transaction-related data. Thus, the reporting component may receive manually entered data in addition to data which is received from the at least one electronic device.

Preferably, the system may comprise an access control component for establishing the user's identity or authorisation prior to allowing the user to access the reporting component. This provides the advantage that unauthorized persons may be prevented from gaining access to the system or the data. The invention is not intended to be limited in respect of the method(s) or device(s) used to establish the user's identity or verify his authorization. For example, a password and username may be required, or biometric analysis may be employed; but other techniques may be used to similar effect.

Preferably, the system may comprise computer hardware and software for storage of the transaction related data, the non transaction-related data and/or software components of the computer-implemented system. The storage medium may be volatile and/or non-volatile, and may be located in the cloud and/or at the entity or any other geographical location.

Preferably, the system may comprise a database for storing the transaction related data, the non transaction-related data, the cash sheet reconciliation report and/or the management report. The database may be located in the cloud.

Preferably, the system may comprise a computing device located at the commercial entity, the device being arranged and configured to receive all or part of the transaction related data or non transaction related data from the at least one electronic device, and send all or part of the transaction related data or non transaction related data to the reporting component. Thus, a server may be provided at the store through which data is fed to the reporting component.

According to a second aspect of the invention, there is provided a computer-implemented system for managing a commercial entity and comprising a cloud-based reporting component configured to:
receive transaction-related and non transaction-related data from at least one electronic device located at the entity;
process the transaction-related and/or non transaction-related data to generate a management report relating to financial and/or non-financial operations or activities occurring within the entity;
communicate at least a portion of the pre-processed or processed data to an accounting component;
provide the management report to a user associated with the entity.

Preferably, the non transaction-related data may relate to at least one of:
an environmental factor present within the entity;
the status of a device operating within the entity;
an employee or other person operating within the entity;
a customer making a transaction within the entity.

Preferably, the at least one electronic device is a Point-of-Sale device, or a cash register, or refrigeration apparatus, or identity-verification apparatus, or security-related device.

Also in accordance with the invention there is provided a computer-implemented method for managing a commercial entity and comprising the step of providing a computer-implemented system in accordance with the above.

Therefore, the system of the present invention may be arranged and configured to serve as a managerial reporting tool to facilitate monitoring, recording and/or reviewing of data relating to the operations of the commercial entity (business) in real time. The invention may be particularly suited for use with small to medium sized business, although large scale business may also appreciate the benefit of the invention. The operations may be financial or non financial in nature, and are operations which may be expected to occur daily or regularly within the typical activities of the entity. In essence, the invention provides the user with a powerful and flexible tool for collecting, storing, processing and accessing a variety of data types relating to a variety of activities occurring within the business. This, in turn, enables the user to manage the business in a more effective and efficient manner, thus saving considerable time, effort and money for the user and his organization.

A main object of the present invention is to provide a cloud based integrated system for integrating cash sheet generation with an accounting & payroll system in real time over a cloud computing network.

Another object of the present invention is to provide a cloud based integrated system for cash sheet management in a real time over a cloud computing network.

Still another object of the present invention is to provide a cloud based integrated system for online accessing of the cash sheet and accounting/payroll information from anywhere by authorized personnel.

Yet another object of the present invention is to automatically obtain cash sheet information from tills/POS/attendance capture networks into the system without manual intervention.

Another object of the present invention is to provide an option for inputting purchases/expenses occurring at POS into the cloud based system along with a copy of invoices/receipts, which may then be automatically posted within an accounts component (or ‘module’).

Another object of the invention is to provide an entity-based reporting component/module within a cloud based system for obtaining and integrating all the management detailed information in the cloud computing environment for reporting data at an entity or sub-entity level.

The reports generated by the present invention include a greater variety of information above and beyond those provided by the current POS or accounting systems in isolation. The invention enables reports to be generated which provide the manager with vital information relating to the daily (financial and non-financial) operations of his business. The accounting software does not report on daily activities such as those comprising the cash sheet reconciliation report; the POS software does not integrate automatically with the accounting software, requiring manual intervention for the export of the POS data. All of this is achieved by the invention in real time, enabling the manager to access the report he needs exactly when he needs it. By contrast, using existing software the manager could wait weeks or months for the accountant/software to process the POS data and produce the requested information.

In summary, the invention provides a cloud based integrated cash sheet management system for integrating cash sheet data with an accounting & payroll module/ERP in real-time over a cloud computing environment. The cloud based integrated cash sheet management system includes a plurality of local servers placed at various retail stores, an accounts module responsible for performing day to day accounting activities, a payroll module responsible for processing the hours worked for employees into their wages payable, a store module responsible for collecting data from the store server and storing the data in the cloud database, a user access control module responsible for controlling cloud user access to the system with a set of pre-defined rules; and a database including accounts data, attendance data and store data. In accordance with an embodiment, the store server can be a physical server in store or a cloud based store local server which is connected to the plurality of tills, attendance capturing system and store terminals for collecting the store data automatically from the store terminals. Further, the system enables a system administrator to enter purchase data, expense data and bank deposits data into the local store server or cloud based server.

The invention can be viewed as providing an intermediary component which replaces the traditional book keeper, by integrating (in an automated, real-time manner) the entity-related data, the accountancy component and the reporting facility.

The store module is configured to perform a set of specified tasks based on commands received from the account module and/or the user control module and/or payroll module. The accounts & payroll modules are configured to perform a set of specified tasks based on commands received from the store module and/or from the user control module. The user interface control module is configured to allow user or admin with relevant authorizations to access relevant modules and the data associated with them.

These and other aspects of the present invention will be apparent from and elucidated with reference to, the embodiment described herein. An embodiment of the present invention will now be described, by way of example only, and with reference to the accompanying drawings, in which:

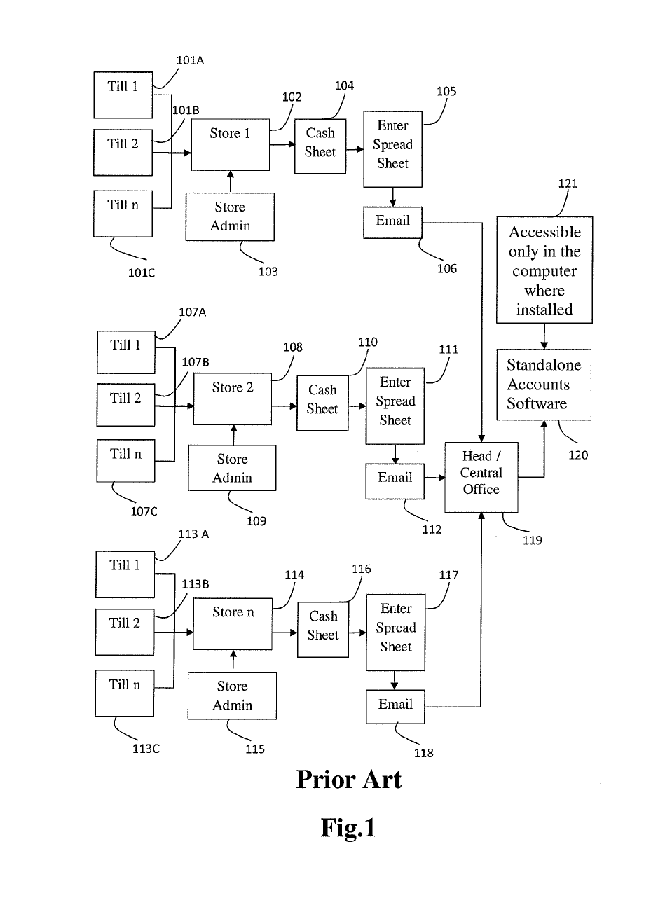

FIG. 1 illustrates a block diagram of a known cash sheet management in a retail store in accordance with the prior art.

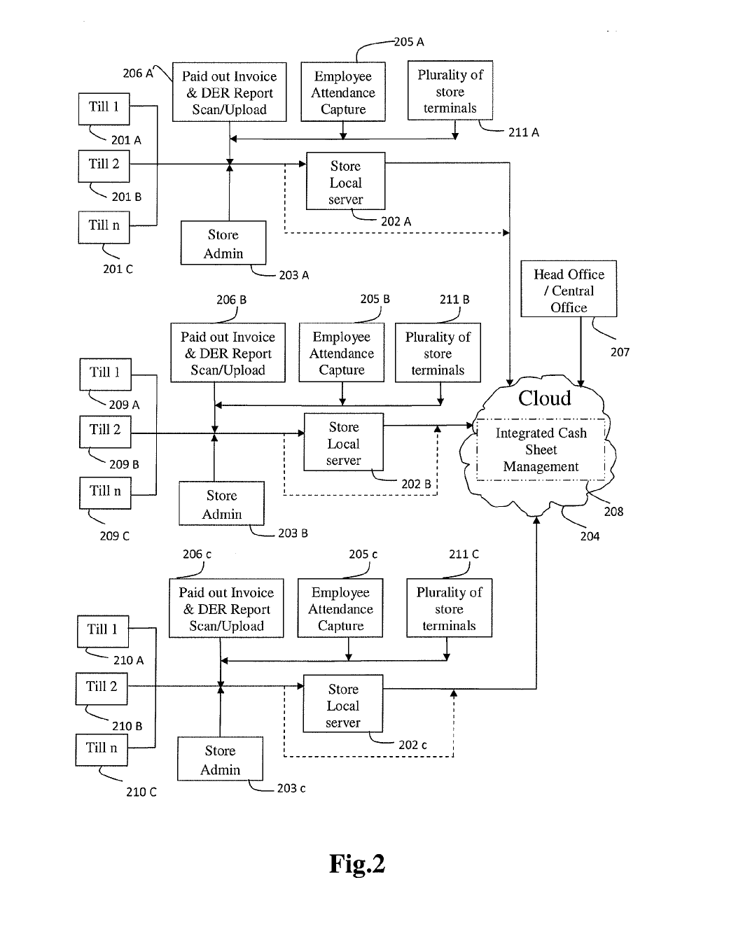

FIG. 2 illustrates a block diagram of a cash sheet management in a real time over a cloud computing network, according to an illustrative embodiment of the invention.

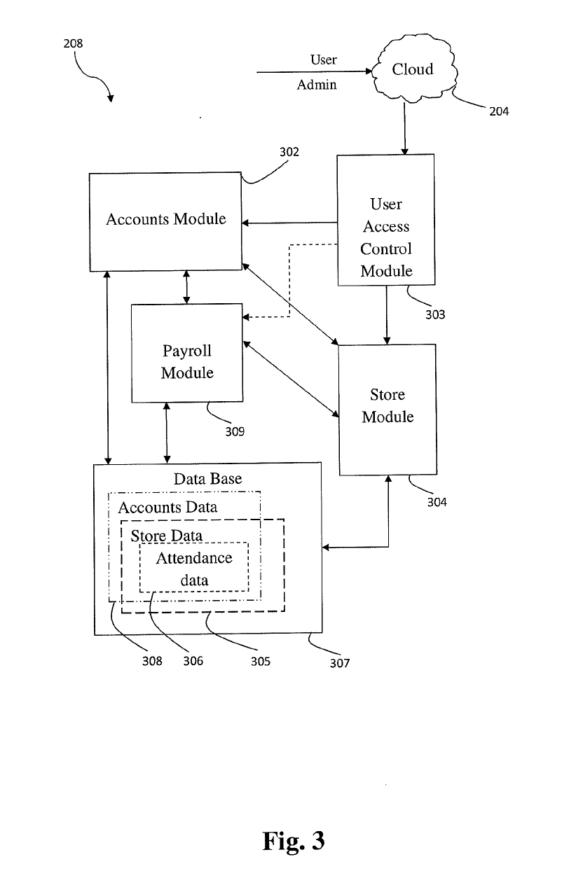

FIG. 3 illustrates a system architecture for cloud based integrating cash sheet management with the accounting and payroll systems, according to an illustrative embodiment of the invention.

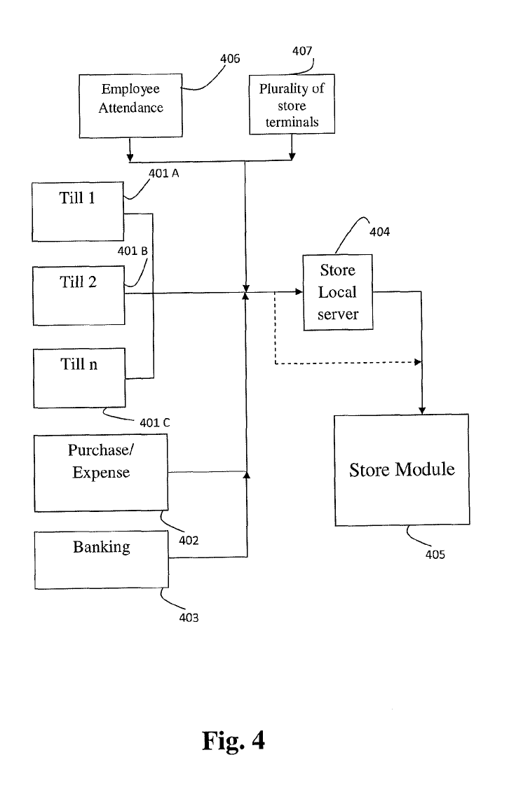

FIG. 4 illustrates the collection of cash sheet and other expenses/purchases via store location, according to an illustrative embodiment of the invention.

FIG. 5 illustrates a simple example of a cash sheet which might be used in accordance with known techniques for reconciling a POS unit at the end of the day.

In the figures, the left-most digit(s) of a reference number identifies the figure in which the reference number first appears. The use of the same reference numbers in different figures indicates similar or identical items.

As outlined above, there is a need to provide a system for managing day to day operations related to cash transactions, cash balances, credit/debit card transactions, funds transfer, bank account reconciliations, employee attendance etc. in a real-time environment and to integrate with the accounting & payroll system. The embodiments herein achieve this by providing a cloud based integrated system that includes a store module, an accounting module, a payroll module, a user access control module and database.

Now referring to FIG. 1, a diagram is shown illustrating a known approach to cash sheet management in a retail store in accordance with the prior art. The prior art system consists primarily of larger custom-made applications for transmitting the cash sheet 104, 110, 116 corresponding to individual stores (i.e. sub-entities) 102, 108, 114 to the head office 119. An example of a simple cash sheet is shown in FIG. 5, for illustrative purposes. The cash sheet will be tailored according to the requirements of the individual business entity. A store comprising of plurality of tills 101A, 101B, and 101C, hereinafter collectively referred to as tills 101, and similarly other tills 107, 113 refers to other stores.

The tills are the point of sales (POS) systems from where the sales are performed. The cash sheets 104, 110, 116 refer to the tabulated amount of sales transaction to formulate a permanent cumulative record which can be entered into a spread sheet 105, 111, 117 or any other software or a printed sheet manually and the syndicated data may be sent to the head/central office 119 via an e-mail, sms message, phone call etc. The administrative personnel at the store 103, 109, 115 can access the data obtained from the plurality of tills 101, 107, 113 and may append necessary changes.

After the syndicated data is reviewed in the head/central office 119 it is uploaded to a standalone accounting software component 120 which can be accessed from a computer wherever the software is installed 121.

Clearly, this approach requires significant time and effort on behalf of the store personnel. Moreover, the manual entry of data introduces a significant risk of error.

FIG. 2 provides a block diagram of cash sheet management of a retail network in a real time environment over a cloud computing network in accordance with one embodiment of the present invention.

It is to be noted that even though the description of the invention has been explained using retail store, it should, in no manner, be construed to limit the scope of the invention. The systems of the invention can apply to any type of business model including a pub, take away, restaurants, service stations, vehicle rental, repairs, wholesalers and other forms of businesses including online retailing.

The retail network consists of plurality of stores (‘sub-entities’) present at various Physical/geographical locations where the retail business is carried out. The stores are connected to plurality of point of sale (POS) systems. Data obtained from the POS stations are stored within the POS system. A cash register (which may also be referred to as a ‘till’) is provided at each POS station, where the individual sales transactions take place and data is generated. Other devices (such as bar code scanners) can also be connected to the POS station for automatic (i.e. non-manual) data entry.

At the close of business, each POS station provides a Day End Report (DER). The details in the DER make up part of the cash sheet information which must be generated for each store. For example, a typical cash sheet contains information related to reconciliation of cash received, sales, cash paid out and banking.

The store manager must also monitor and supervise employee attendance. The stores are provided with attendance capturing systems which obtain and record data relating to attendance/working hours. Typically, the attendance system is able to record the times of employee logins and logouts, break timings and so on. This data is saved in the store local server (i.e. a computing system provided within the store) or within the attendance system. This attendance data provides a second portion of the cash sheet information.

The store can be connected to plurality of store terminals which can include but not limited to the attendance capturing systems, POS, computers, printers, scanners, temperature capture, chillers, freezers, ovens, CCTV, ATM machines, vending machines and cooking equipments, wherein the store terminals can collect the data/information (also termed as store data) from the retail outlet and transfer to the store local server.

The tills 201A, 201B, 201C (hereinafter collectively referred as group of tills 201) are connected to a store server 202A provided in a store. Similarly, other groups of tills 209, 210 are connected to respective store servers 202B, 202C. Furthermore, all the store servers 202A, 202B, 202C (hereinafter collectively referred as store server 202) is connected to a cloud based integrated cash management system 208 via a cloud computing environment 204—i.e. a reporting component in accordance with the present invention.

Administrative staff 203A can access the cloud based integrated reporting component. Further, all store admin 203A, 203B, 203C (hereinafter collectively referred as store admin 203) are responsible for maintaining and handling the bank deposits, purchases, expenses. They are also responsible for monitoring the cash sheet information through the cloud based system.

Tills 201 refer to a POS terminal or, more generally, to the hardware and software used to manage the transactions performed by a salesperson accessible interface. In the retail store, a plurality of terminals is provided for implementing different functionalities and for capturing store data. The till system provided in the store allows the creation and printing of receipts.

The tills 201 can be automated to save time and to increase the efficiency of the retail management process. This ensures that the orders are accurately filled, inventory is always in stock and supplies are shipped to customers in a timely manner. Accordingly, automating the tills can avoid manual entry of data into spreadsheets which may prove to be laborious/error prone and does facilitate effective time-based decision making.

The paid out invoice and DER scan/upload 206A, 206B, 206C (hereinafter collectively referred to as paid out invoice and DER scan/upload 206) is verified for the actual till contents for a session balance with the expected amount during the transaction process. A paid out invoice is created when money is removed from the till for incidental expenses. The DER is generated when cashing up the till (typically at the close of business/day end) and it may contain a range of accounting details that can be used for management information reports and accounting purposes. The paid out invoice and DER are saved in the cloud database present in the cloud based system 208.

The attendance capture system 205A, 205B, 205C (hereinafter collectively referred to as employee attendance capture system 205) provides timely reporting and historical information to track the attendance patterns of the employees. It can also be configured to formulate work schedules, maintain employee information, and perform payroll calculations (and more). In some embodiments, the attendance capturing terminal 205 can also be a part of POS terminal.

The employee information and other formulated/processed data is stored in the store server 202 which can be made available to the administrative staff in order to evaluate the data and effectively measure accuracy in each till system.

The store server 202 is configured to automatically accumulate/receive the cash sheet data from the plurality of point of sales (POS) systems or tills 201, plurality of store terminals 211 and the attendance system 205 without any human intervention. The accumulated data, including cash sheet data from the individual store server 202, is passed into the cloud based management system 208. In some arrangements, the store server 202 can also be a cloud based server. In such cases, the store server and the reporting component of the invention 208 could be integrated.

The store admin 203 can access the cloud based system 208 through a web browser, mobile phone application, desktop computer, laptop, tablet, PDA, smart phone or any current or future computing/telecommunications device while the accounting/payroll ERP system and data are stored on servers at remote locations.

In use, a user from head office/central office 207 can access the cloud based management system 208 through the cloud computing environment 204.

In certain configurations of the system, the system admin 203 can also enter the cash sheet data obtained from the tills 201, 209, 210 into the cloud based system 208 manually.

FIG. 3 illustrates a system architecture for integrating the cloud based system with the ‘back end’ accounting & payroll system.

The cloud based management system 208 provides a managerial and reporting tool which is integrated with an accounting & payroll ERP module.

Accordingly, an illustrative embodiment of the invention includes:
a plurality of store servers placed at various respective retail stores;
an attendance system
an accounts module 302 responsible for performing day to day accounting activities
a payroll module 309 responsible for processing employee wages
a store module 304 responsible for communicating and/or connecting with the store server to collect and/or synchronize the data including cash sheet data obtained from the store server; and
a user access control module 303 responsible for controlling access to the system with a set of pre-defined rules.

Further, the integrated cash management system 208 includes database 307, wherein accounts data 308, attendance data 306 and store data 305 are stored.

The store module 304 is configured to synchronize and/or collect the data from the store server and to pass the data into the database 307 to accumulate as store data 305. Further, the store module 304 is configured to perform set of specified task based on commands received from the account module 302 and/or from the user control module 303 and/or payroll module 309. For example, the store data 305 can be merged with the accounts data 308 and attendance data 306 at predetermined time or pre-defined rules set by the user or system admin or assigned command in the account module 302 and/or user control module 303.

The accounts module 302 and payroll modules 309 are configured to provide all the functions and reports required to efficiently and effectively control the financial and managerial aspects of the business.

Furthermore, the accounts module 302 and payroll module 309 are configured to record, classify and summarize the financial/attendance transactions automatically and transmit the information for authorized persons to access, thus eliminating the tedious work associated with accounting and payroll processing. The account module 302 and payroll module 309 are configured to perform set of specified tasks based on commands received from the store module 304 and/or from the user control module 303.

The user interface control module 303 is configured to allow user or administrative staff with relevant authorizations to access relevant modules and the data associated with them. For instance, the accounts user is authorized to access only the accounts module 302 to view the accounts data 308, and also allows the accounts user to append additional entries related to other financial transactions of the store and or the company.

The accounts module 302 is configured to enable gathering of specified data from the database and provide it to the administrative staff who are access it through the user access control module 303. Therefore, the transaction data obtained from the till in real-time is made available to the accounts software for further processing, all in real-time.

The payroll module 309 is configured to enable to gather specified data from the database and can present the same to the store admin accessing through the user access control module 303. Therefore, the cash sheet data obtained from the attendance system in real-time is made available in payroll module and attendance data for further processing in accordance with present invention, all in real-time.

All the data on the cloud including databases, accounts module, payroll module, store module and user access control module can be backed up in at least two different geographical locations which are retainable any time from any place for a minimum rolling period of 7 years, hence also complying with the legal requirements.

FIG. 4 illustrates the collection of data including cash sheet data and other expenses/purchases via store location according to an embodiment. The store module 405 is configured to receive cash sheets from plurality of tills 401A, 401B, and 401C, hereinafter collectively referred to as till 401. Additionally, the store module 405 is configured to receive plurality of other financial transactions related to purchases and/or expenses 402 and banking 403.

Moreover, the store module 405 is configured to receive information regarding the employee attendance 406 and also to receive data from the plurality of terminals 407.

In certain embodiments, a system admin 203 can feed the other financial transaction 402/403 such as purchase data, expense data and bank deposits data into the store module 405 via store server 404 and or directly into the cloud application system 204.

Data from a variety of electronic sources within the store can be fed into the cloud-based system and used to generate a managerial report to assist the user (store manager/owner) in running the business. Some such data might include environmental data relating to the store. For example, a store might sell chilled food products which are stored within refrigerated cabinets. Legal requirements may need to be met regarding the temperature maintained within the chilled cabinets. A temperature sensing device may be used to detect the temperature within the cabinet and transmit that data to the system, so that it can be included in the report generated by the invention. Other types of data gathering devices relating to different types of data could be used in conjunction with the system, as dictated by the nature of the business concerned.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented system for managing a commercial entity and comprising a cloud-based reporting component configured to:
receive transaction-related data from at least one electronic device located at a commercial entity;
process at least a portion of the transaction-related data to generate a cash-sheet reconciliation report;
communicate at least a portion of the transaction-related data to an accounting component; and
provide the cash-sheet reconciliation report to a user associated with the commercial entity.

2. The system according to claim 1, wherein the reporting component is further configured to receive non-transaction-related data relating to at least one of:
an environmental factor present within the commercial entity;
the status of an electronic device operating within the commercial entity;
person within the commercial entity; and
a customer making a transaction within the commercial entity;
and process the non-transaction-related data to generate a management report relating to operations or activities occurring within the commercial entity.

3. The system according to claim 1, wherein at least one electronic device is selected from the group consisting of a Point-of-Sale device, a cash register, refrigeration apparatus, identity-verification apparatus, and security-related device.

4. The system according to claim 1, wherein the transaction-related data relates to financial operations occurring at the commercial entity.

5. The system according to claim 2, wherein the non-transaction-related data relates to at least one of:
the temperature within the commercial entity;
the temperature within a refrigeration device at the commercial entity;
employee working hours;
licensing requirements;
statutory/legislative requirements; and
person verification.

6. The system according to claim 1 further comprising an on-screen interface to enable a user to at least one of:
input data for sending to the reporting component;
access data previously received by the reporting component; and
access at least one report generated by the reporting component.

7. The system according to claim 1, wherein at least a portion of the transaction-related data is received from at least one electronic device without one or both manual input of the data and manual intervention.

8. The system according to claim 1, wherein the reporting component is configured to format or process the data prior to communicating it to the accounting component:
wherein the accounting component is a software component executing upon a processor; and
wherein the reporting component is a software component executing upon a processor.

9. The system according to claim 1, wherein the reporting component is configured such that at least one report can be customized to include or exclude information specified by a user.

10. The system according to claim 1, wherein at least one report is generated on a pre-scheduled basis or upon demand by a user.

11. The system according to claim 1, wherein at least one report is provided to a user via electronic means and/or in a digital format.

12. The system according to claim 1, wherein at least one report is provided to a user via a step selected from the group consisting of an email message, an SMS message, display via a web browser, and transfer via the internet.

13. The system according to claim 1 further comprising an on-screen interface to enable a user to manually enter one or both of the transaction- and non-transaction-related data.

14. The system according to claim 1 further comprising an access control component for establishing a user's identity or authorization prior to allowing a user to access the reporting component.

15. The system according to claim 1, wherein the commercial entity is selected from the group consisting of a retail outlet, a shop, a restaurant, a food outlet, a goods distribution business, a non-profitable organization, and a charitable organization.

16. The system according to claim 1, wherein the accounting component and the cloud-based component are integrated.

17. The system according to claim 1, wherein the accounting component is cloud-based.

18. The system according to claim 1, wherein the transaction-related data includes one or more of purchase data, expense data, and bank deposit data.

19. The system according to claim 1, wherein the transaction-related data is received from a plurality of one or more electronic tills and electronic point-of-sale systems.

20. The system according to claim 1 further comprising computer hardware and software for storage of one or more of the transaction related data, the non-transaction-related data and software components of the computer-implemented system.

21. The system according to claim 1 further comprising a database for storing one or more of the transaction-related data, the non-transaction-related data, the cash-sheet reconciliation report and the management report.

22. The system according to claim 1, wherein the system is arranged and configured to serve as a managerial reporting tool to facilitate one or more of monitoring, recording and reviewing of data relating to the daily financial and non-financial operations of the commercial entity in real time.

23. The system according to claim 2, wherein the management report includes one or both of employee attendance information and payroll information.

24. The system according to claim 1 further comprising a computing device located at the commercial entity, the computing device being arranged and configured to receive at least part of either of both of the transaction-related data and non-transaction-related data from at least one electronic device, and send at least part of either of both of the transaction-related data and non-transaction-related data to the reporting component.

25. The system according to claim 1, wherein:
the commercial entity comprises a plurality of sub-entities;
the reporting component receives transaction-related data from at least one of the sub-entities; and
the cash-sheet reconciliation report includes information relating to at least one of the sub-entities.

26. The system according to claim 1, wherein one or both of the cash-sheet reconciliation report and the management report is provided to a user via a device selected from the group consisting of a device selected from the group consisting of a mobile telephone and computer accessible by a user.

27. A computer-implemented system for managing a commercial entity and comprising a cloud-based reporting component configured to:
receive transaction-related and non-transaction-related data from at least one electronic device located at the commercial entity;
process at least a portion of one or both of the transaction-related and non-transaction-related data to generate a management report relating to at least a portion of one or more of financial operations, non-financial operations, and activities occurring within the commercial entity;
communicate at least a portion of one or both of the transaction-related and non-transaction-related data to an accounting component;
provide the management report to a user associated with the commercial entity.

28. The computer-implemented system according to claim 27, wherein the non-transaction-related data relates to at least one of:
an environmental factor present within the commercial entity;
the status of an electronic device operating within the commercial entity;
person within the commercial entity;
a customer making a transaction within the commercial entity.

29. The computer-implemented system according to claim 27, wherein:
at least one electronic device is selected from the group consisting of a Point-of-Sale device, a cash register, refrigeration apparatus, identity-verification apparatus, and security-related device.

30. A computer-implemented method for managing a commercial entity comprising the step of providing the computer-implemented system according to claim 1.

31. The system according to claim 1, wherein the at least a portion of the transaction-related data communicated to the accounting component is pre-processed transaction-related data.

32. The system according to claim 1, wherein the at least a portion of the transaction-related data communicated to the accounting component is processed transaction-related data.

33. The system according to claim 2, wherein the non-transaction-related data relates to biometric data for establishing one or both of the identity or age of a person.

34. The system according to claim 27, wherein the at least a portion of one or both of the transaction-related and non-transaction-related communicated to the accounting component is pre-processed one or both of the transaction-related and non-transaction-related data.

35. The system according to claim 27, wherein the at least a portion of one or both of the transaction-related and non-transaction-related communicated to the accounting component is processed one or both of the transaction-related and non-transaction-related data.
